(19) United States
(12) Patent Application Publication
(10) Pub. No.: US 2003/0104261 A1
(43) Pub. Date: Jun. 5, 2003

(54) Fuel cell reactant delivery system

(75) Inventors: Marie A. Schnitzer, Latham, NY (US); Arne W. Ballantine, Round Lake, NY (US); Scott K. Lobdell, Clifton Park, NY (US); Sean S. Lyons, Berne, NY (US)

Correspondence Address: FRED PRUNER - TROP, PRUNER, HU P.C., 8554 KATY FREEWAY, SUITE 100, HOUSTON, TX, 77024, US

(73) Assignee: Plug Power Inc., Latham, NY

(21) Appl. No.: 10/209,747

(22) Filed: Jul. 31, 2002

Related U.S. Application Data
(60) Provisional application No. 60/309,079, filed on Jul. 31, 2001.

(51) Int. Cl. H01M 8/02; H01M 8/04; H01M 8/10

(52) U.S. Cl. 429/34; 429/33; 429/25; 429/22; 429/13

(57) ABSTRACT

The invention generally relates to fuel cell reactant delivery systems and methods for delivering fuel to fuel cell systems, where air or oxygen is injected into a fuel stream containing hydrogen, such that a portion of the hydrogen reacts with the oxygen to form water that humidifies a fuel cell membrane as the fuel stream is passed into the fuel cell. In a preferred embodiment, the invention relates to dead-headed, pure hydrogen PEM fuel cell systems, but the invention is also applicable to other fuel cell system configurations.

### CROSS REFERENCE TO RELATED APPLICATIONS

This application claims priority under 35 USC 119(e) from U.S. Provisional Application No. 60/309,079, filed Jul. 31, 2001, naming Schnitzer et al. as inventors, and titled “FUEL CELL REACTANT DELIVERY SYSTEM.” That application is incorporated herein by reference in its entirety and for all purposes.

### BACKGROUND

The invention generally relates to fuel cell reactant delivery systems and methods for delivering fuel to fuel cell systems.

A fuel cell is an electrochemical device that converts chemical energy produced by a reaction directly into electrical energy. For example, one type of fuel cell includes a polymer electrolyte membrane (PEM), often called a proton exchange membrane, that permits only protons to pass between an anode and a cathode of the fuel cell. At the anode, diatomic hydrogen (a fuel) is reacted to produce protons that pass through the PEM. The electrons produced by this reaction travel through circuitry that is external to the fuel cell to form an electrical current. At the cathode, oxygen is reduced and reacts with the protons to form water. The anodic and cathodic reactions are described by the following equations:

H₂→2H⁺+2e⁻ at the anode of the cell, and

O₂+4H⁺+4e⁻→2H₂O at the cathode of the cell.

A typical fuel cell has a terminal voltage of up to about one volt DC. For purposes of producing much larger voltages, multiple fuel cells may be assembled together to form an arrangement called a fuel cell stack, an arrangement in which the fuel cells are electrically coupled together in series to form a larger DC voltage (a voltage near 100 volts DC, for example) and to provide more power.

The fuel cell stack may include flow field plates (graphite composite or metal plates, as examples) that are stacked one on top of the other. The plates may include various surface flow field channels and orifices to, as examples, route the reactants and products through the fuel cell stack. A PEM is sandwiched between each anode and cathode flow field plate. Electrically conductive gas diffusion layers (GDLs) may be located on each side of each PEM to act as a gas diffusion media and in some cases to provide a support for the fuel cell catalysts. In this manner, reactant gases from each side of the PEM may pass along the flow field channels and diffuse through the GDLs to reach the PEM. The PEM and its adjacent pair of catalyst layers are often referred to as a membrane electrode assembly (MEA). An MEA sandwiched by adjacent GDL layers is often referred to as a membrane electrode unit (MEU).

A fuel cell system may include a fuel processor that converts a hydrocarbon (natural gas or propane, as examples) into a fuel flow for the fuel cell stack. For a given output power of the fuel cell stack, the fuel flow to the stack must satisfy the appropriate stoichiometric ratios governed by the equations listed above. Thus, a controller of the fuel cell system may monitor the output power of the stack and based on the monitored output power, estimate the fuel flow to satisfy the appropriate stoichiometric ratios. In this manner, the controller regulates the fuel processor to produce this flow, and in response to the controller detecting a change in the output power, the controller estimates a new rate of fuel flow and controls the fuel processor accordingly.

The fuel cell system may provide power to a load, such as a load that is formed from residential appliances and electrical devices that may be selectively turned on and off to vary the power that is demanded by the load. Thus, the load may not be constant, but rather the power that is consumed by the load may vary over time and abruptly change in steps. For example, if the fuel cell system provides power to a house, different appliances/electrical devices of the house may be turned on and off at different times to cause the load to vary in a stepwise fashion over time. Fuel cell systems adapted to accommodate variable loads are sometimes referred to as “load following” systems.

There is a continuing need for integrated fuel cell systems and associated process designed to achieve objectives including the forgoing in a robust, cost-effective manner.

### SUMMARY

The invention generally relates to fuel cell reactant delivery systems and methods for delivering fuel to fuel cell systems, where air or oxygen is injected into a fuel stream containing hydrogen, such that a portion of the hydrogen reacts with the oxygen to form water that humidifies a fuel cell membrane as the fuel stream is passed into the fuel cell.

In one aspect, the invention provides a reactant delivery system for a PEM fuel cell. The fuel cell has an anode, a cathode, a hydrogen rich anode reactant supply stream, and an oxidant cathode reactant supply stream. As examples, the hydrogen rich anode reactant supply stream can refer to pure hydrogen, concentrated hydrogen streams, reformate, etc., and the oxidant cathode reactant supply stream can refer to oxygen, air, etc. The anode of the fuel cell is in fluid communication with the hydrogen rich anode reactant supply stream, such that the anode receives hydrogen from the hydrogen rich anode reactant supply stream. Similarly, the cathode of the fuel cell is in fluid communication with the oxidant cathode reactant supply stream such that the cathode receives oxygen from the oxidant cathode reactant supply stream. The oxidant cathode reactant supply stream is also in fluid communication with the hydrogen rich anode reactant supply stream and is configured such that an amount of oxidant is flowed from the oxidant cathode reactant supply stream into the hydrogen rich anode reactant supply stream, the amount being sufficient to form water vapor.

As an example, the water vapor formed can be used to humidify a polymer electrolyte membrane in a fuel cell as the water vapor is carried into the fuel cell with the hydrogen rich anode reactant supply stream. Such membranes may include sulfonated fluorocarbon polymer membranes or other types of membranes that require humidification to function properly.

In certain embodiments, it may be desirable to maintain the amount of oxygen flowed into the hydrogen rich anode reactant supply stream below a desired threshold. For example, it may be desirable to provide less than 20 mole percent oxygen in the hydrogen rich anode reactant supply stream to avoid a potentially explosive mixture of hydrogen and oxygen.

Various embodiments may also include systems with a dead-headed fuel supply, or a recirculated fuel supply. As known in the art, the term “dead-headed” refers to a system where the fuel stream dead-ends into the anode of the fuel cell. The anode chambers of such systems may be periodically vented to prevent the accumulation of inert gases in the anode chamber as the hydrogen reacts. Systems with recirculated fuel supplies generally flow a fuel stream through the fuel cell, and then recirculate (e.g., via a blower) a portion of the fuel stream exhausted from the fuel cell back into the inlet of the fuel cell to minimize the amount of unreacted hydrogen that is exhausted from the system.

In another aspect, the invention provides another reactant delivery system for a pure hydrogen PEM fuel cell. The fuel cell has an anode chamber, a hydrogen supply, and an oxygen supply. The anode chamber is in fluid communication with the hydrogen supply, and the anode chamber is in fluid communication with the oxygen supply. In some embodiments, the hydrogen supply contains less than 50 parts per million carbon monoxide. In some embodiments, the hydrogen supply is a hydrogen vessel, such as a pressure tank or any other vessel containing hydrogen. The invention is not limited by the particular pressure associated with such a vessel. As described above, some embodiments may relate to dead-headed hydrogen supplies, or systems with hydrogen recirculation systems. For example, a hydrogen recirculation system could include a recirculation conduit adapted to flow hydrogen from an outlet of the anode chamber to an inlet of the anode chamber.

In various embodiments, the oxygen supply may include a blower adapted to flow ambient air through the fuel cell, or in other cases the oxygen supply may include a gas vessel such as a pressure tank containing pressurized air or oxygen. The invention is not limited by the particular pressure associated with such a vessel.

Some embodiments may include a first humidification catalyst bed in fluid communication with the anode chamber of the fuel cell. The first humidification catalyst bed is adapted to receive hydrogen from the hydrogen supply and oxygen from the oxygen supply, and to react a portion of the hydrogen with the oxygen to form water vapor. As an example, the first humidification catalyst bed may include a platinum catalyst. Some embodiments may also include a second humidification catalyst bed in fluid communication with the first humidification catalyst bed and the anode chamber. In such systems, the second humidification catalyst bed may be adapted to receive hydrogen from the first humidification catalyst bed and oxygen from the oxygen supply, and to react a portion of the hydrogen with the oxygen to form water vapor.

Some embodiments may include a valve connected to the oxygen supply and adapted to vary an amount of oxygen supplied from the oxygen supply. For example, in some cases the valve can be a pressure matching regulator adapted to vary a pressure of oxygen exhausted from the oxygen supply in proportion to a pressure of hydrogen exhausted from the hydrogen supply. Alternatively, a variable output valve may be included that is connected to the oxygen supply, wherein a controller is adapted to execute a measurement of a performance parameter of the fuel cell, and further adapted to vary an amount of oxygen supplied from the oxygen supply in response to the measurement of the performance parameter. As examples, such performance parameters may include temperatures pressures, fuel cell voltages or output currents, etc. Embodiments of the invention may also include an orifice connected to the oxygen supply and adapted to regulate an amount of oxygen supplied from the oxygen supply.

In another aspect, the invention provides a method of supplying humidified fuel to a PEM fuel cell, including at least the following steps: (1) providing an inlet conduit of an anode chamber of the fuel cell with hydrogen; (2) providing the inlet conduit of the anode chamber of the fuel cell with oxygen; and (3) reacting the hydrogen and oxygen to produce water vapor. The various system details discussed above may also be applied in this context. For example, the hydrogen associated with such methods may contain less than 50 parts per million carbon monoxide in some embodiments, the anode chamber of the fuel cell can be dead-headed, etc.

In some embodiments, the step of reacting the hydrogen and oxygen to produce water vapor may include reacting the hydrogen and oxygen in a first humidification catalyst bed in fluid communication with the anode chamber, where the first humidification catalyst bed is adapted to receive the hydrogen and oxygen, and to react a portion of the hydrogen with the oxygen to form water vapor.

In some embodiments, the step of providing the inlet conduit of the anode chamber of the fuel cell with oxygen may include: operating a controller to execute a measurement of a performance parameter of the fuel cell; and actuating a valve in response to the measurement of the performance parameter to vary an amount of oxygen reacted.

In another aspect, the invention provides a method of supplying humidified fuel to a PEM fuel cell, including at least the following steps: (1) providing a humidification catalyst bed with a gas mixture comprising hydrogen and oxygen; (2) reacting a portion of the hydrogen with the oxygen to form a fuel gas mixture comprising water vapor and hydrogen; and (3) reacting the fuel gas mixture in an anode chamber of a PEM fuel cell. Such methods may also include any of the steps described above, an may refer to systems incorporating any of the features discussed herein.

Advantages and other features of the invention will become apparent from the following description, drawing and claims.

### BRIEF DESCRIPTION OF THE DRAWINGS

FIG. 1 is a schematic view of a fuel cell stack assembly.

FIG. 2 is a schematic view of a fuel cell flow field plate.

FIG. 3 is a schematic view of a fuel cell flow field plate.

FIG. 4 is a partial, side elevation view of a fuel cell such as those shown in the stack of FIG. 1.

FIG. 5 is a schematic view of a hydration system.

FIG. 6 is a schematic view of a control loop for the hydration system of FIG. 5.

### DETAILED DESCRIPTION

As known in the art, the use of sub-saturated reactants in a PEM fuel cell may dry out the fuel cell membrane and in turn lead to premature membrane decay. A simplified humidification scheme may be utilized in such systems. Air may be injected into the anode inlet to react with the hydrogen in the presence of a catalyst to form water. The water will then be carried into the stack where it can be used to humidify the membrane.

Typically air bleed (as disclosed in U.S. Pat. No. 4,910,099) has been used to oxidize carbon monoxide from a fuel stream leaving a reformer prior to entry into the fuel cell stack, to prevent carbon monoxide poisoning of the fuel cells. However, in a dead headed system utilizing substantially pure hydrogen, no air bleed would be necessary since no carbon monoxide or other harmful substances would be present in the anode fuel stream. As an example, some embodiments of the present invention may be used with fuel cell systems where the hydrogen supply contains less than 50 parts per million carbon monoxide.

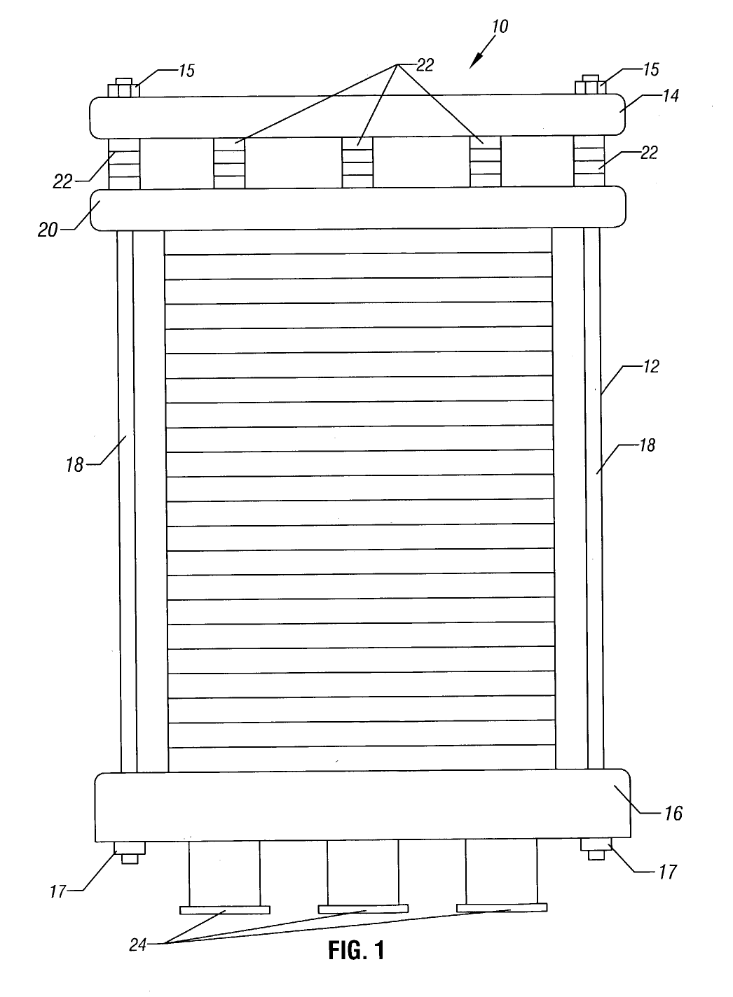

FIG. 1 depicts an exemplary fuel cell stack assembly 10, an assembly that includes a stack 12 of flow plates that are clamped together under a compressive force. To accomplish this, the assembly 10 typically includes end plate 16 and spring plate 20 that are located on opposite ends of the stack 12 to compress the flow plates that are located between the plates. Besides the end plate 16 and spring plate 20, the assembly 10 may include a mechanism to ensure that a compressive force is maintained on the stack 12 over time, as components within the stack 12 may settle, or flatten, over time and otherwise relieve any applied compressive force.

As an example of this compressive mechanism, the assembly 10 may include another end plate 14 that is secured to the end plate 16 through tie rods 18 that extend through corresponding holes of the spring plate 20. The spring plate 20 is located between the end plate 14 and the stack 12, and coiled compression springs 22 may reside between the end plate 14 and spring plate 20. The tie rods 18 slide through openings in the spring plate 20 and are secured at their ends to the end plates 14 and 16 through nuts 15 and 17. Due to this arrangement, the springs 22 remain compressed to exert a compressive force on the stack 12 over time even if the components of the stack 12 compress.

To establish connections for external conduits (hoses and/or pipes) to communicate the reactants, coolants and product with the manifold passageways of the stack 12, the assembly 10 may include short connector conduits, or pipes 24, that may be integrally formed with the end plate 16 to form a one piece end plate assembly (for example, pipes 24 may be welded to end plate 16).

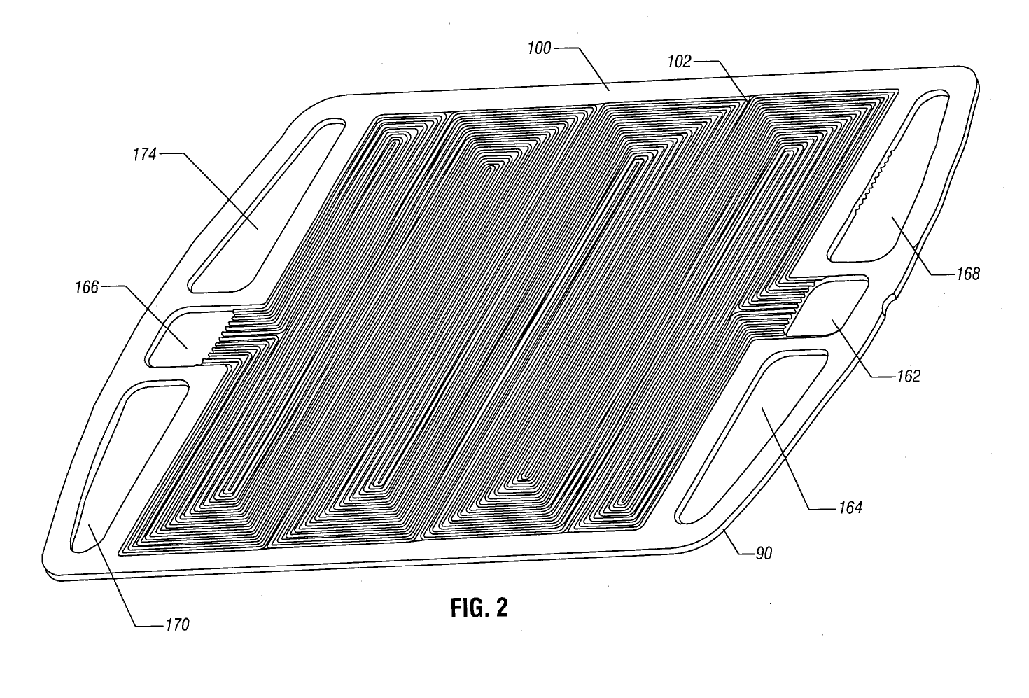

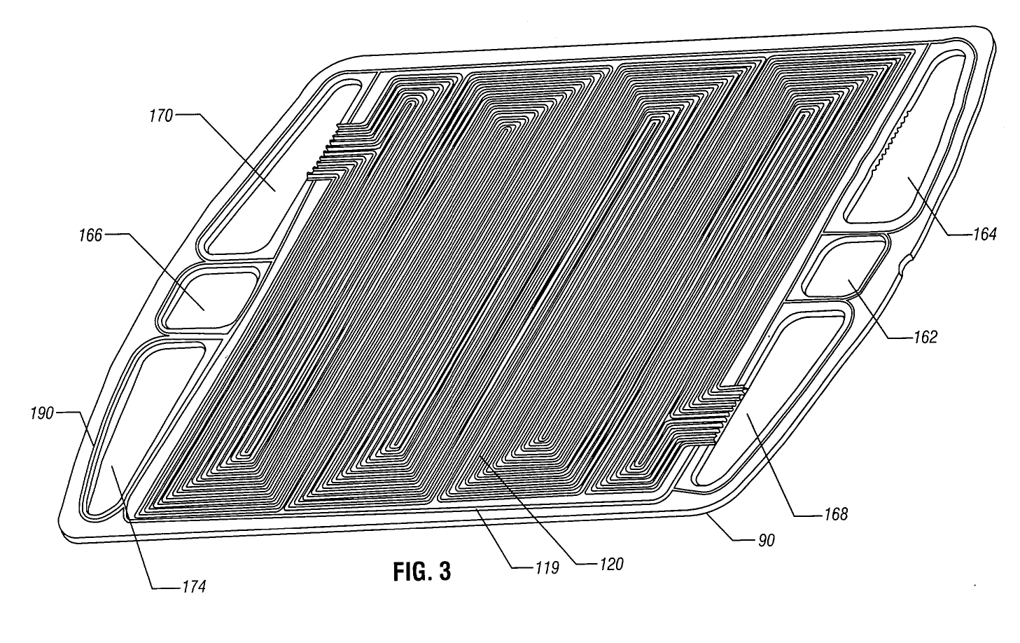

FIG. 2 depicts a surface 100 of an exemplary flow field plate 90. The surface 100 includes flow channels 102 for communicating a coolant to remove heat from the fuel cell stack 10. Flow channels 120 (see FIG. 3) on an opposite surface 119 of the plate 90 may be used for purposes of communicating hydrogen (for an anode plate configuration) or air (for a cathode plate configuration) to a fuel cell MEU.

An opening 170 of the plate 90 forms part of a vertical inlet passageway of the manifold for introducing hydrogen to the flow channels 120 (see FIG. 3); and an opening 168 of the plate 90 forms part of a vertical outlet passageway of the manifold for removing hydrogen from the flow channels 120. Similarly, openings 174 and 164 in the plate 90 form partial vertical inlet and outlet passageways, respectively, of the manifold for communicating an air flow (that provides oxygen to the fuel cells); and openings 162 and 166 form partial vertical inlet and outlet passageways, respectively, of the manifold for communicating the coolant to the flow channels 102. While flow channels generally have uniform square or circular cross-sectional profiles, channels are also known that have trapezoidal cross-section profiles (channel walls are not perpendicular to channel floors), and square and trapezoidal profiles with channel walls and floors intersected at selected angles or in rounded portions.

As shown in FIG. 3, the flow field plate 90 may be designed so that a flow gasket 190 may be formed on either surface 119 or 100 of plate 90. Conventionally, each flow field plate includes a gasket groove on one side to receive a gasket. However, the gasket 190 may also be adhered to or formed on either side of the plate 90.

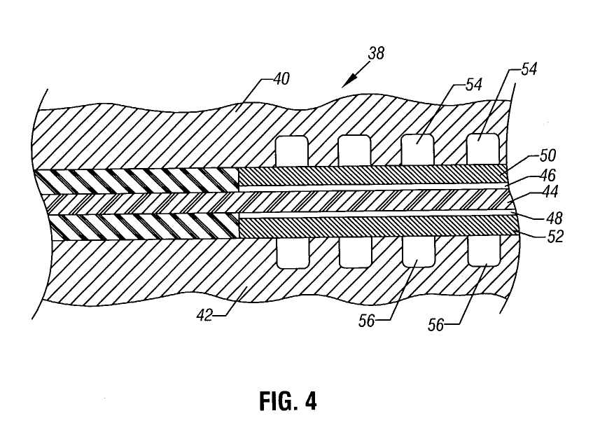

Referring to FIG. 4, an example of a fuel cell 38 is shown such as those included in the stack shown in FIG. 1, utilizing flow field plates 40 and 42 such as those shown in FIGS. 2 and 3. As an example, fluid flow field plate 40 might serve as an anode side of the fuel cell, circulating fuel through flow field channels 54. Similarly, fluid flow field plate 42 might serve as a cathode side of the fuel cell, circulating oxidant through flow field channels 56. Fuel cell 38 includes a PEM, such as a sulfonated flourocarbon polymer (e.g., Du Pont's Nafion™ PEM). Catalysts 46 and 48, which facilitate chemical reactions, are applied to the anode and cathode sides, respectively, of solid electrolyte 44. Catalysts 46 and 48 may be constructed from platinum or other materials known in the art. The MEA is sandwiched between anode and cathode GDLs 50 and 52, respectively, which may be formed with a resilient and conductive material such as carbon fabric or carbon fiber paper.

The portion of the membrane in a PEM fuel cell where a reactant gas is introduced into the membrane (i.e., the leading edge of the membrane) can begin to dry out if the reactant gas has a dew point below the temperature of the leading edge of the membrane. This can decrease the useful life of the membrane. It can therefore be advantageous for the reactant gas to have a dew point that is about the same as the leading edge of the membrane. This can be accomplished, for example, by hydrating the reactant gas before it enters the fuel cell. When using a substantially dry (or sub-saturated) hydrogen anode inlet stream, oxygen may be injected into the anode inlet in the presence of a catalyst to form water and thereby hydrate the incoming anode reactant.

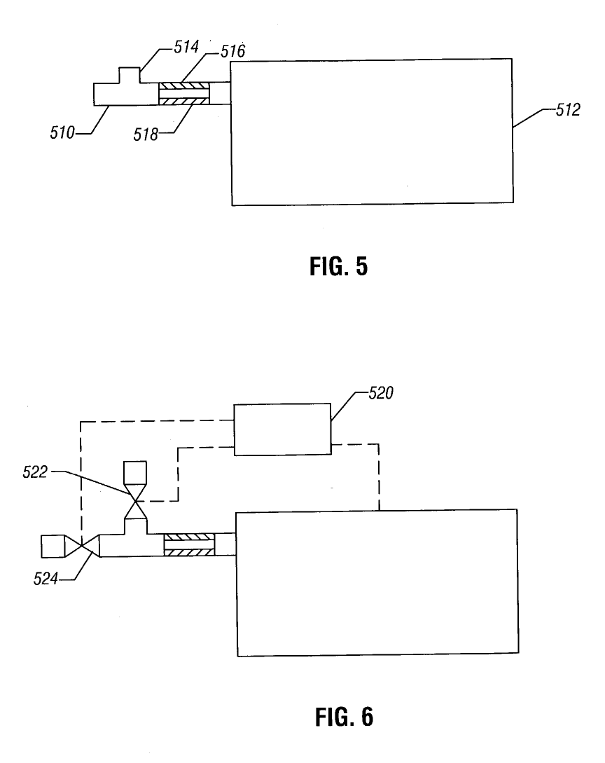

FIG. 5 illustrates one embodiment of a hydration scheme in accordance with the present invention. The anode reactant gas (e.g. a dry or sub-saturated hydrogen rich stream) enters fluid conduit 510. This gas stream may be referred to variously as a fuel stream, hydrogen stream, a hydrogen rich anode reactant supply stream, etc. Oxygen (either substantially pure or in the form of air) is injected into the incoming anode reactant gas upstream of the fuel cell stack 512 at junction 514. This gas stream may be referred to variously as an oxidant stream, an oxygen stream, a cathode inlet stream, an oxidant cathode reactant supply stream, etc.

The reactant/oxygen mixture then travels to housing 516, which contains a catalyst 518 (e.g. platinum). Catalyst 518 facilitates the reaction of hydrogen and oxygen to form water, which is carried by the anode reactant gas stream to the membrane for humidification. Alternatively, the catalyst may be placed in the anode inlet plenum or the anode catalyst located on the MEU may be utilized to facilitate the hydrogen and oxygen reaction. In some embodiments (not shown), the catalyst bed 518 may be divided into multiple stages, such as a first humidification catalyst bed and a second humidification catalyst bed, which may be provided in the same or separate housings.

FIG. 6 illustrates a control scheme for the embodiment of FIG. 5. A controller 520 is coupled to valves 522 and 524. The controller can open, close, modulate, or restrict the flow of either the hydrogen or oxygen alone or in combination as may be necessary to properly hydrate the membrane. A feed back parameter (e.g. cell voltage) may be coupled to the controller so that operation of the fuel cell stack is monitored and variation of inlet flows can be controlled. Alternatively, mass flow sensors may be placed on the inlet conduits so that a proper ratio of hydrogen to oxygen can be maintained. Alternatively, valve 522 can be a pressure matching regulator tied at some proportion to the pressure of the hydrogen. In some embodiments, valve 522 can be a simple orifice in the oxygen supply line serving as a flow restrictor.

A method for operating a system such as the one shown in FIG. 6 may include at least the following steps: (1) providing the inlet conduit 510 of the anode chamber of the fuel cell 512 with hydrogen; (2) providing the inlet conduit 510 of the anode chamber of the fuel cell 512 with oxygen; and (3) reacting the hydrogen and oxygen to produce water vapor. The various system details discussed above may also be applied in this context.

Heat produced by the hydrogen-oxygen reaction can be utilized by the fuel cell system in multiple ways. A quantity of water may be boiled to produce steam, which can be injected at the anode inlet to achieve an even more efficient anode humidification scheme. Also, other system fluids (e.g. coolant) may be heated and circulated to allow the system to reach a permissive start up temperature (45-50 degrees C.).

When air (containing approx. 20% oxygen) and hydrogen are mixed, the resulting mixture generally becomes combustible when the air content increases beyond approximately 20%. So in order to maintain a proper level of safety, in some embodiments, a series of air inlets and catalyst beds may be utilized to step the humidification up in increments, such that the risk of combustion is reduced.

While the invention has been disclosed with respect to a limited number of embodiments, those skilled in the art, having the benefit of this disclosure will appreciate numerous modifications and variations therefrom. It is intended that the invention covers all such modifications and variations as fall within the true spirit and scope of the invention.

What is claimed is:

1. A reactant delivery system for a pure hydrogen PEM fuel cell, comprising:
a fuel cell having an anode chamber, a hydrogen supply, and an oxygen supply;
wherein the anode chamber is in fluid communication with the hydrogen supply; and
wherein the anode chamber is in fluid communication with the oxygen supply.

2. The reactant delivery system of claim 1, wherein the hydrogen supply contains less than 50 parts per million carbon monoxide.

3. The reactant delivery system of claim 1, wherein the hydrogen supply comprises a hydrogen vessel.

4. The reactant delivery system of claim 1, wherein the hydrogen supply is dead-headed.

5. The reactant delivery system of claim 1, further comprising a recirculation conduit adapted to flow hydrogen from an outlet of the anode chamber to an inlet of the anode chamber.

6. The reactant delivery system of claim 1, wherein the oxygen supply comprises a blower adapted to flow ambient air through the fuel cell.

7. The reactant delivery system of claim 1, wherein the oxygen supply comprises a gas vessel.

8. The reactant delivery system of claim 1, wherein the fuel cell comprises a sulfonated fluorocarbon polymer membrane.

9. The reactant delivery system of claim 1, further comprising:
a first humidification catalyst bed in fluid communication with the anode chamber, the first humidification catalyst bed being adapted to receive hydrogen from the hydrogen supply and oxygen from the oxygen supply, and to react a portion of the hydrogen with the oxygen to form water vapor.

10. The reactant delivery system of claim 9, wherein the first humidification catalyst bed comprises a platinum catalyst.

11. The reactant delivery system of claim 1, further comprising:
a valve connected to the oxygen supply and adapted to vary an amount of oxygen supplied from the oxygen supply.

12. The reactant delivery system of claim 1, further comprising:
an orifice connected to the oxygen supply and adapted to regulate an amount of oxygen supplied from the oxygen supply.

13. The reactant delivery system of claim 11, wherein the valve is a pressure matching regulator adapted to vary a pressure of oxygen exhausted from the oxygen supply in proportion to a pressure of hydrogen exhausted from the hydrogen supply.

14. The reactant delivery system of claim 1, further comprising:
a variable output valve connected to the oxygen supply; and
a controller adapted to execute a measurement of a performance parameter of the fuel cell, and further adapted to vary an amount of oxygen supplied from the oxygen supply in response to the measurement of the performance parameter.

15. The reactant delivery system of claim 1, further comprising:
a second humidification catalyst bed in fluid communication with the first humidification catalyst bed and the anode chamber, the second humidification catalyst bed being adapted to receive hydrogen from the first humidification catalyst bed and oxygen from the oxygen supply, and to react a portion of the hydrogen with the oxygen to form water vapor.

16. A method of supplying humidified fuel to a PEM fuel cell, comprising:
providing an inlet conduit of an anode chamber of the fuel cell with hydrogen;
providing the inlet conduit of the anode chamber of the fuel cell with oxygen; and
reacting the hydrogen and oxygen to produce water vapor.

17. The method of claim 16, wherein the hydrogen contains less than 50 parts per million carbon monoxide.

18. The method of claim 16, wherein the anode chamber of the fuel cell is dead-headed.

19. The method of claim 16, wherein the step of reacting the hydrogen and oxygen to produce water vapor comprises:
reacting the hydrogen and oxygen in a first humidification catalyst bed in fluid communication with the anode chamber, the first humidification catalyst bed being adapted to receive the hydrogen and oxygen, and to react a portion of the hydrogen with the oxygen to form water vapor.

20. The method of claim 16, wherein the step of providing the inlet conduit of the anode chamber of the fuel cell with oxygen comprises:
operating a controller to execute a measurement of a performance parameter of the fuel cell;
actuating a valve in response to the measurement of the performance parameter to vary an amount of oxygen reacted.

21. A method of supplying humidified fuel to a PEM fuel cell, comprising:
providing a humidification catalyst bed with a gas mixture comprising hydrogen and oxygen;
reacting a portion of the hydrogen with the oxygen to form a fuel gas mixture comprising water vapor and hydrogen; and
reacting the fuel gas mixture in an anode chamber of a PEM fuel cell.

22. The method of claim 21, wherein the gas mixture comprises less than 20 mole percent oxygen.

23. A reactant delivery system for a PEM fuel cell, comprising:
a fuel cell having an anode, a cathode, a hydrogen rich anode reactant supply stream, and an oxidant cathode reactant supply stream, the anode being in fluid communication with the hydrogen rich anode reactant supply stream, the cathode being in fluid communication with the oxidant cathode reactant supply stream; and
wherein the oxidant cathode reactant supply stream is also in fluid communication with the hydrogen rich anode reactant supply stream and is configured to flow an amount of oxidant into the hydrogen rich anode reactant supply stream sufficient to form water vapor.

24. The reactant delivery system of claim 23, wherein the water vapor provides humidification to polymer electrolyte membrane in the fuel cell.

25. The reactant delivery system of claim 23, wherein the amount of oxidant provided to the hydrogen rich anode reactant supply stream provides less than 20 mole percent oxygen in the hydrogen rich anode reactant supply stream.

26. The reactant delivery system of claim 23, wherein the hydrogen rich anode reactant supply stream is dead-headed.

27. The reactant delivery system of claim 23, further comprising a recirculation conduit adapted to flow hydrogen from an outlet of the anode chamber to an inlet of the anode chamber.
